(19) United States
(12) Patent Application Publication
(10) Pub. No.: US 2025/0229568 A1
(43) Pub. Date: Jul. 17, 2025

(54) SPRAY PEN

(71) Applicant: Yantai Greenery Tools Co., Ltd., Yantai (CN)

(72) Inventors: Changlei FAN, Yantai (CN); Bo YU, Yantai (CN); Yongchao XIE, Yantai (CN)

(21) Appl. No.: 18/733,805

(22) Filed: Jun. 4, 2024

(30) Foreign Application Priority Data
Jan. 15, 2024 (CN) 202410056032.7

(51) Int. Cl. B44D 3/22

(52) U.S. Cl. CPC B44D 3/22

(57) ABSTRACT

A spray pen provided, the spray pen includes a body, a housing and a gripping sleeve, the body include an air inlet portion, an air guiding connector is provided on the housing, the air guiding connector is connected with the air inlet; an air transportation channel is defined in the air guiding connector, and the air guiding connector is connected with an air pump; air pumped by the air pump is sent to the air inlet portion through the air transportation channel of the air guiding connector; the gripping sleeve being provided in the housing, the gripping sleeve is configured for an user to hold. With the housing and the gripping sleeve, providing a reasonable support point for holding the spray pen, making it more comfortable for users to hold and reducing pen fatigue.

### CROSS REFERENCE TO RELATED APPLICATIONS

This application claims foreign priority of Chinese Patent Application No. 202410056032.7, filed on Jan. 15, 2024 in the China National Intellectual Property Administration, the disclosures of all of which are hereby incorporated by reference.

### TECHNICAL FIELD

The present disclosure relates to the technical field of spray tools technology, in particular to a spray pen.

### BACKGROUND

Currently, spray pen is a tool used to spray paint, which can create a detailed lines and present a soft gradient effect, has widely application in beauty, makeup, painting and other fields.

In some related technologies, the spray pen usually includes a body, the body is equipped with an air guiding channel and a nozzle needle inside the air guiding channel, the nozzle needle can move forward along a shaft of the nozzle body, an inlet valve may connected with the air guiding channel, a color cup is connected to the air guiding channel, and an inlet end of the inlet valve is connected to an air pump, an air inlet end of the inlet valve is connected with the air pump, and the nozzle port is blocked or opened under the moving of the needle. When the spray pen is used, the pigment is loaded in the color cup, and the user holds the spray pen, opening the inlet valve and the air pump, moving the spray needle backward to open the nozzle, and the pigment is ejected through the nozzle.

However, when the user uses the spray pen, it is inconvenient to hold, and it is easy to fatigue problems.

### SUMMARY

The present disclosure provides a spray pen, to solve the technical problem that the exiting spray pen is inconvenient to hold and easy to fatigue.

To realize the above objective, the present disclosure provides a spray pen, including:
a body, and the body includes an air inlet portion;
a housing, and a air guiding connector is provided on the housing, the air guiding connector is connected with the air inlet; an air transportation channel is defined in the air guiding connector, and the air guiding connector is connected with an air pump; air pumped by the air pump is sent to the air inlet portion through the air transportation channel of the air guiding connector;
a gripping sleeve, the gripping sleeve is provided in the housing, the gripping sleeve is configured for an user to hold.

The beneficial effect of the embodiment of the present application: the spray pen provided by the present application includes a body, a housing, and the housing is used to sheath the gripping sleeve, air guiding connector is provided on the housing, the air guiding connector is configured to connect with the body. When the user uses the spray pen of the embodiment of the present application, placing the fingertip of the index finger at the front of the body, and operating the control switch 120 of the body with the thumb to control the control switch. This embodiment provides a reasonable support point for the user by setting the housing and the gripping sleeve, and can guide the user to hold the spray pen correctly and comfortably, making the user to hold the spray pen more comfortable and reducing the user's pen fatigue.

In another embodiment, 2. the gripping sleeve includes a front surface, a rear surface and a first side top surface;
the front surface and the rear surface are located on opposite sides of the housing; and
the front surface and the rear surface are perpendicular to a first direction, wherein, the first direction is a direction from a tail of the body toward a nozzle of the body;
the first side top surface is located on a side of a front surface, and the first side top surface is configured for the user to place an index finger during using.

In another embodiment, the gripping sleeve also includes a second side top surface;
the first side top surface and the second side top surface are located on opposite sides of the body;
the second side top surface is configured for the user to place a thumb during using.
In another embodiment, 4. the first side top surface and the second side top surface are both tilted downward, and a tilt direction is opposite with the first direction.

In another embodiment, an upper portion of the gripping sleeve is protruded forward along a nozzle end of the first direction.
the front surface includes a first surface, a second surface, a third surface and a fourth surface;
the first surface is a protruded end surface of the gripping sleeve, and the first surface is configured for the user to place a middle finger during using;
the second surface is a protruded lower surface of the gripping sleeve, and the second is surface is configured for the user to place a ring finger and a little thumb during using;
the third surface and the fourth surface are located on opposite sides of the first surface, and the third surface and the fourth surface both extend downward and extend to both sides of the second face.

In another embodiment, the first side top surface and the second side top surface are smoothly transition connected with the rear surface;
the second surface is smoothly transition connected with the first surface;
the third surface and the fourth surface are smoothly transition connected with the second surface, respectively.

In another embodiment, a first raised edge is provided between a first area and the third surface, and the first area is formed by the second side top surface and the rear surface;
a second raised edge is provided between a second area and the fourth surface, and the second area is formed by the first side top surface and the rear surface.

In another embodiment, at least some area of the front surface is provided with anti-skid lines.

In another embodiment, the gripping sleeve includes an opening end and a mounting end, and the housing is sheathed in the gripping sleeve;
a protrusion is provided on the mounting end, and a installing slot is defined on the protrusion, a penetration hole is defined on a bottom of the installing slot, and the installing slot runs through both sides of the protrusion in the first direction;
the body is located in the installing slot, and two ends of the body extend from two ends of the installing slot along the first direction;
the air inlet portion and the air guiding connector are extended into the penetration hole, and connected inside the penetration hole;
the first side top surface and the second side top surface are located on two sides of the installing slot.

In another embodiment, the gripping sleeve is fixed connected the housing.

In another embodiment, the gripping sleeve and the housing are integrated molding.

In another embodiment, the gripping sleeve is a soft adhesive holder.

In another embodiment, a plurality of reinforcements are provided inside the gripping sleeve near the mounting end;
the plurality of the reinforcements extend radially up to the gripping sleeve, and the plurality of the reinforcements are distributed at circumferential intervals along the gripping sleeve.

In another embodiment, among the plurality of the reinforcements, at least 3 reinforcements toward a surface of the opening end and fit a surface of the mounting end.

In another embodiment, the spray pen also include the air pump and a power supply, the air pump and the power supply are provided inside the housing, the air pump is electrically connected with the power supply, and a air outlet of the air pump is connected with a second end of the air guiding connector.

In another embodiment, the housing includes a middle part, an upper part and a lower part, the upper part and the lower part are detachable connected with two ends of the middle part, respectively; and
the air guiding connector is connected with the upper part of the housing.

In another embodiment, a platform is provided on an outer side of the housing;
when the gripping sleeve sheaths the housing, an end surface of the opening end of the gripping sleeve is located on the platform.

In addition to the technical problems solved by the present application described above, the technical features constituting the technical solutions and the beneficial effects brought by the technical features of these technical solutions, the other technical problems provided by the present application, the other technical features included in the technical solutions and the beneficial effects brought by these technical features will be further detailed in the specific embodiment.

### BRIEF DESCRIPTION OF THE DRAWINGS

The accompanying drawings are incorporated into the specification and form a part of this application, illustrating embodiments in accordance with the present application and used together with the specification to explain the technical solutions of the present application

FIG. 1 is a schematic structural diagram of a spray pen according to an embodiment of the present disclosure.

FIG. 2 is a schematic structural diagram of the spray pen in FIG. 1 with a gripping sleeve removed.

FIG. 3 is a vertical view of the gripping sleeve in FIG. 1.

FIG. 4 is a schematic structural diagram of the gripping sleeve in FIG. 1.

FIG. 5 is a schematic structural diagram of the gripping sleeve in FIG. 1 from another perspective.

FIG. 6 is a top view of the gripping sleeve in FIG. 1.

FIG. 7 is an exploded view of the spray pen in FIG. 1.

FIG. 8 is a schematic diagram of the housing of the spray pen in FIG. 1.

FIG. 9 is a schematic diagram of the spray pen which it is holded by an user.

FIG. 10 is a schematic diagram of the spray pen which it is operated by an user.

FIG. 11 is another schematic structural diagram of the spray pen.

### LABELS AND DESCRIPTION

100 body, 101 tail, 102 nozzle, 110 air inlet portion, 120 control switch, 130 pigment cup, 200 housing, 210 air guiding connector, 220 platform, 240 air pump, 250 power supply, 260 upper part, 270 middle part, 280 lower part, 211 air transportation channel, 300 gripping sleeve, 301 anti-skid lines, 302 opening end, 303 mounting end, 310 second side top surface, 320 first side top surface, 331 front surface, 330 rear surface, 340 first surface, 350 second surface, 360 third surface, 370 fourth surface, 380 protrusion, 390 reinforcement, 361 first raised edge, 371 second raised edge, 381 installing slot, 3811 penetration hole, 3812 weight reduction hole.

According the above drawings, clear embodiments of this application have been shown, and more detailed descriptions will be provided in the following text. These figures and textual descriptions are not intended to limit the scope of this application, but rather to illustrate the concept of this application to those skilled in the art by referring to specific embodiments.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

### Embodiment 1

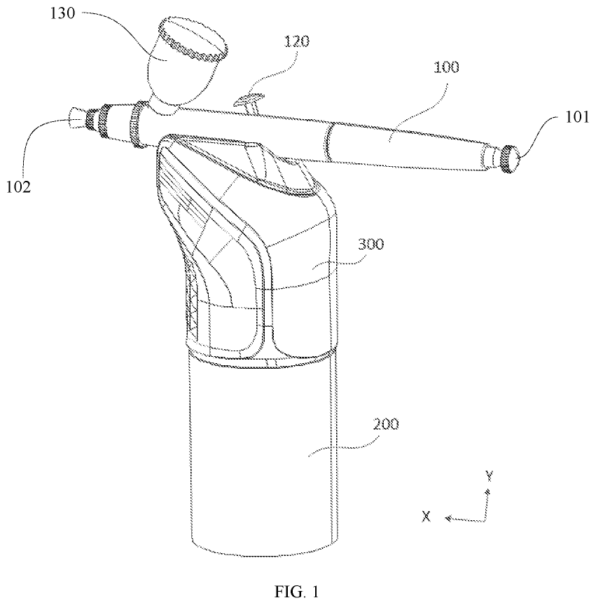

Please refers to FIGS. 1 to 3, 7 and 8, the spray pen provided by the first embodiment includes a body 100, a housing 200 and a gripping sleeve 300, the body 100 includes an air inlet portion 110, an air guiding channel 211 is provided inside the body, and a spray needle is provided in the air guiding channel 211. The spray needle can move forward and backward along an axial direction of the nozzle 102. A pigment cup 130 is provided on the body 100 and the pigment cup 130 is connected with the air guiding channel 211, and a nozzle opening is connected with the air guiding channel 211, the air inlet portion 110 is connected with the air guiding channel 211.

An air guiding connector 210 is provided on the housing 200, the air guiding connector 210 is connected with the air inlet; an air transportation channel is defined in the air guiding connector 210, and the air guiding connector 210 is connected with an air pump 240; air pumped by the air pump 240 is sent to the air inlet portion 110 through the air transportation channel of the air guiding connector 210. That is, the body 100 implements connection fixation with the housing 200 through the mating connection of the air inlet portion 110 and the air guiding connector 210.

In this embodiment, the gripping sleeve 300 is provided in the housing, the gripping sleeve 300 is configured for an user to hold. When the user uses the spray pen provided by this embodiment of the present application, the user's palm and fingers work together to grip the gripping sleeve 300 and the housing 200, and the back end of the spray pen is placed at the first web space, placing the fingertip of the index finger at the front of the body, and operating the control switch 120 of the body with the thumb to control the control switch. This embodiment provides a reasonable support point for the user by setting the housing 200 and the gripping sleeve 300, and can guide the user to hold the spray pen correctly and comfortably, making the user to hold the spray pen more comfortable and reducing the user's pen fatigue.

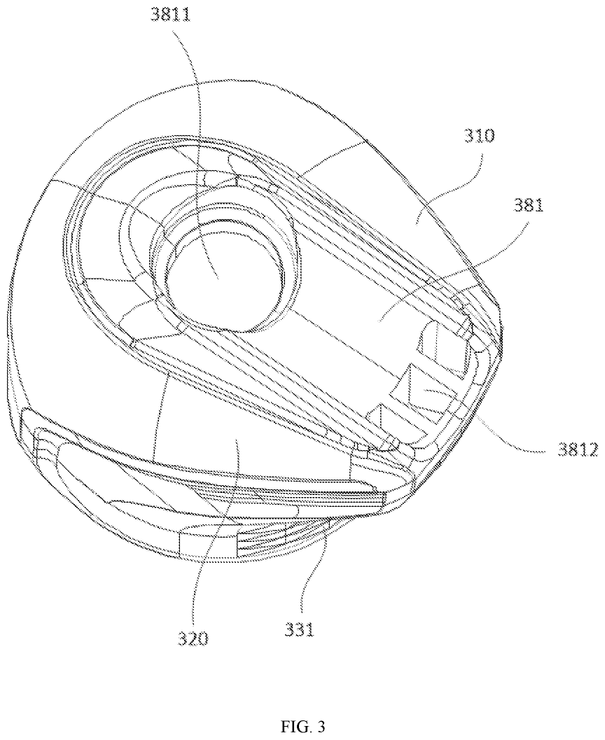

For example, as shown in FIGS. 1, 3, 4, and 5, the gripping sleeve 300 includes a front surface 331, a rear surface 330 and a first side top surface 320. Wherein, the front surface and the rear surface are located on opposite sides of the housing; and the front surface and the rear surface 330 are perpendicular to a first direction, wherein, the first direction is a direction from a tail 101 of the body toward a nozzle 102 of the body. That is, the front surface 331 locates on the front of the gripping sleeve 300 along the first direction, wherein the first direction is a X direction of FIGS. 1 and 3. The rear surface 330 locates on the back of the gripping sleeve 300 along the first direction. The first side top surface 320 locates on one side of the body 100, the first side top surface 320 is configured to place an index finger during using. That is, when the user uses the spray pen of the present application, the user's palm and fingers work together to grip the gripping sleeve 300 and the housing 200, the user's palm fits the rear surface (full or partially fit), and the back end of the spray pen is placed at the first web space, placing the fingertip of the index finger at the front of the body, and operating the control switch 120 of the body with the thumb to control the control switch. This embodiment provides a reasonable support point for the user by setting the housing 200 and the gripping sleeve 300, and can guide the user to hold the spray pen correctly and comfortably, making the user to hold the spray pen more comfortable and reducing the user's pen fatigue.

In some embodiment, the gripping sleeve also includes a second side top surface 310, the first side top surface 320 and the second side top surface 310 are located on opposite sides of the top of the body 100; the second side top surface 310 is configured for the user to place a thumb during using, when the user holds the spray pen, they can place their thumb on the second side top surface 31. When the user operates the control switch 120, they can lift and extend their thumb to control the control switch 120 of the body. Thus making it comfortable to hold the spray pen. That is, when the user uses the spray pen of the present application, the user's palm and fingers work together to grip the gripping sleeve 300 and the housing 200, the user's palm fits the rear surface (full or partially fit), and the back end of the spray pen is placed at the first web space, placing the fingertip of the index finger at the front of the body, and operating the control switch 120 of the body with the thumb to control the control switch. This embodiment provides a reasonable support point for the user by setting the housing 200 and the gripping sleeve 300, and can guide the user to hold the spray pen correctly and comfortably, making the user to hold the spray pen more comfortable and reducing the user's pen fatigue.

In another embodiment, the first side top surface 320 and the second side top surface 310 are both tilted downward, and a tilt direction is opposite with the first direction, to fit the direction of the user's fingers when holding the spray pen, making it more comfortable for the user to hold the spray pen.

In another embodiment, an upper portion of the gripping sleeve 300 is protruded forward along a front end (nozzle end) of the first direction. The front surface 331 includes a first surface 340, a second surface 350, a third surface 360 and a fourth surface 370. Wherein, the first surface 340 is a protruded end surface of the gripping sleeve that protrudes forward, and the first surface 340 is configured for the user to place a middle finger during using. The second surface 350 is a protruded lower surface of the gripping sleeve that protrudes forward, and the second surface 350 is configured for the user to place a ring finger and a little thumb during using. The third surface 360 and the fourth surface 370 are located on opposite sides of the first surface 340, and the third surface 360 and the fourth surface 370 both extend downward and extend to both sides of the second face 350.

It is worth noting that in this embodiment, the side surfaces of the gripping sleeve 300 also belongs to a part of the front surface 331.

For example, in some embodiments, the first side top surface 320 and the second side top surface 310 are smoothly transition connected with the rear surface, the second surface 350 is smoothly transition connected with the first surface 340, the third surface 360 and the fourth surface 370 are smoothly transition connected with the second surface 350, respectively. This structure of smoothly transition can increase the comfort of the user holding the spray pen and enhance the aesthetics of the gripping sleeve 300.

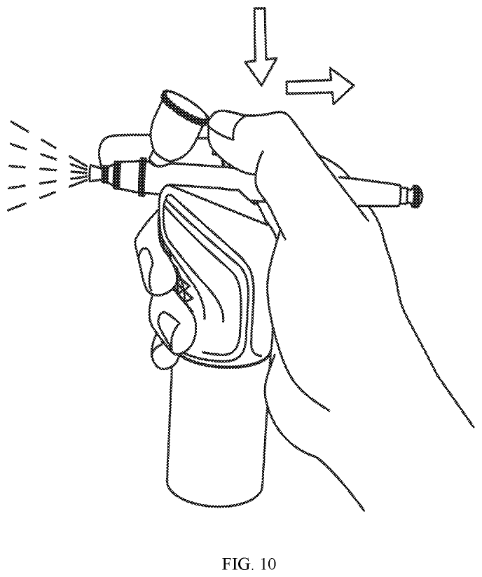

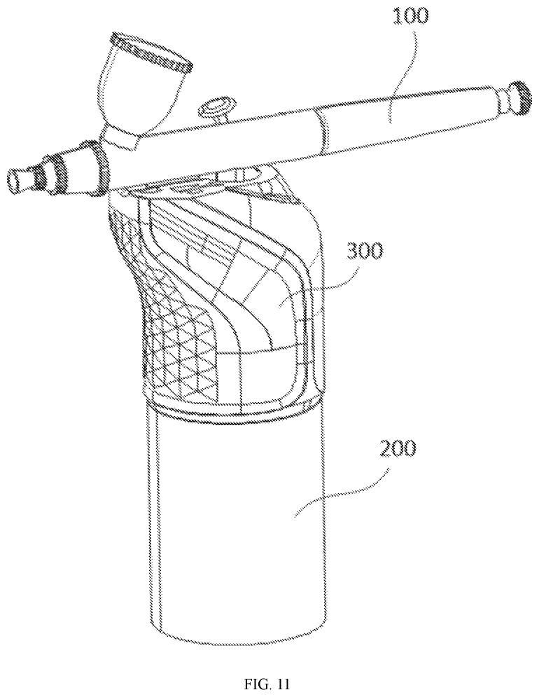

In another embodiment, as shown in FIG. 9 and FIG. 10, when the user uses the spray pen of the present application, the user's palm and fingers work together to grip the gripping sleeve 300 and the housing 200, the user's palm fits the rear surface (full or partially fit), and the back end of the spray pen is placed at the first web space, placing the fingertip of the index finger at the front of the body 100, and the lower part of the user's index finger is placed on the first side top surface 320. When the user holds the spray pen, the thumb is placed on the second side top surface 310, and when operating the control switch 120, lifting and extending the thumb to the control switch 120, to control the control switch 120. And the middle finger is placed on the first surface 340, the ring finger and little thumb can naturally place on the second side 350, an of course, the user's middle finger, ring finger, and little thumb can also be naturally mounted on the front surface 331. With the construction of the gripping sleeve 300, can guide the user to hold the spray pen correctly and comfortably, making the user to hold the spray pen more comfortable and reducing the user's pen fatigue.

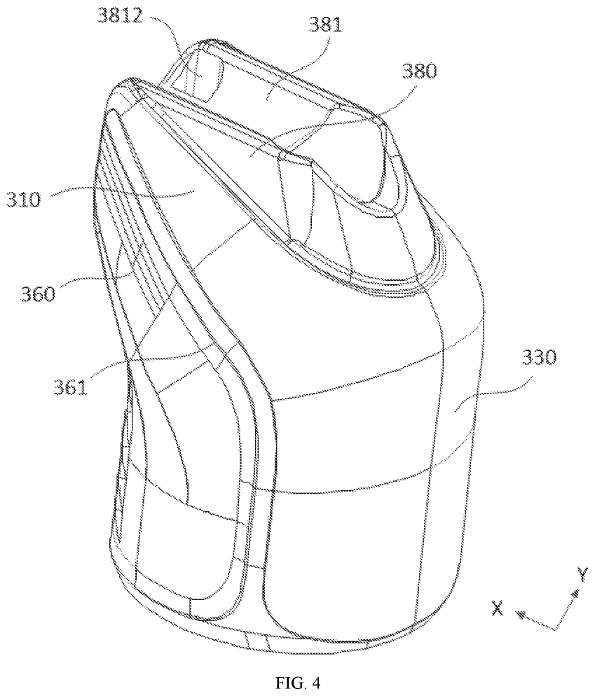

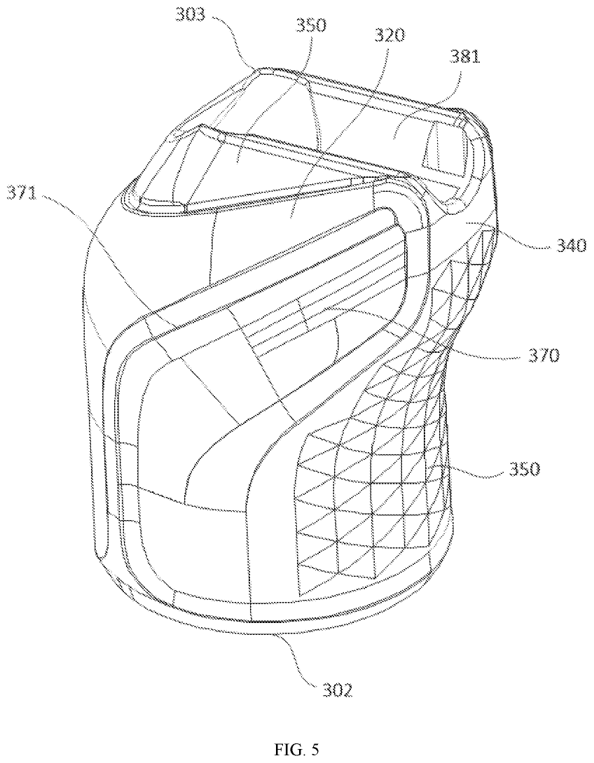

Please refers to FIG. 4 and FIG. 5, to enhance the aesthetics of the gripping sleeve 300, in some embodiments, a first raised edge 361 is provided between a first area and the third surface 360, and the first area is formed by the second side top surface 310 and the rear surface 330, a second raised edge 362 is provided between a second area and the fourth surface 370, and the second area is formed by the first side top surface 320 and the rear surface 330.

Please refers to FIG. 3, in some embodiments, to reduce the material amount of the gripping sleeve 300, to lower production cost of the gripping sleeve 300, and to reduce the weight of the gripping sleeve 300, a plurality of weight reduction holes are defined on the protruding part of the gripping part 300.

Please refers to FIG. 5, in some embodiments, at least some area of the front surface 331 is provided with anti-skid lines 301, the anti-skid lines 301 can avoid the problem of users sweating and slipping their hands when using the spray pen for a long time.

For example, the anti-skid lines 301 are round groove anti-skid lines, the anti-skid lines 301 are several rotundity grooves that formed by lines or patterns, or the anti-skid lines 301 are polygon grooves. It is worth noting that the polygon grooves include triangle groove.

Please refers to FIG. 4 and FIG. 5, in some embodiments, the gripping sleeve 300 includes an opening end 302 and a mounting end 303, and the housing 200 is sheathed in the gripping sleeve 300. A protrusion 380 is provided on the mounting end, and a installing slot 381 is defined on the protrusion 380, a penetration hole 3811 is defined on a bottom of the installing slot 381. The body 100 is located in the installing slot 381. And two ends of the body 100 extend from two ends of the installing slot 381 along the first direction, respectively; the air inlet portion 110 and the air guiding connector 210 are extended into the penetration hole 3811, and connected inside the penetration hole 3811. The first side top surface 320 and the second side top surface 310 are located on two sides of the installing slot. Thus, the protrusion 380 partially wraps around the body 100, concealing the air inlet portion 110 of the body 100 and the air guiding connector 210 of the housing 200, making the spray pen more aesthetically and improving user experience.

For example, in some embodiments, the installing slot 381 is an arc-shaped groove.

For example, air guiding connector 210 has a first end and a second end, and the air transportation channel connects the first end and the second end of the air guiding connector 210. The first end of the air guiding connector 210 extends into the penetration hole 3811 and is connected to the air inlet portion 110. The second end of the air guiding connector 210 passes through the housing 200 and extends into the interior of the housing 200. The second end of the air guiding connector 210 is configured to be connected to the outlet of the air pump 240.

In some embodiment, the gripping sleeve 300 and the housing 200 can be a split structure, can also be a fixed connection or an integrated structure.

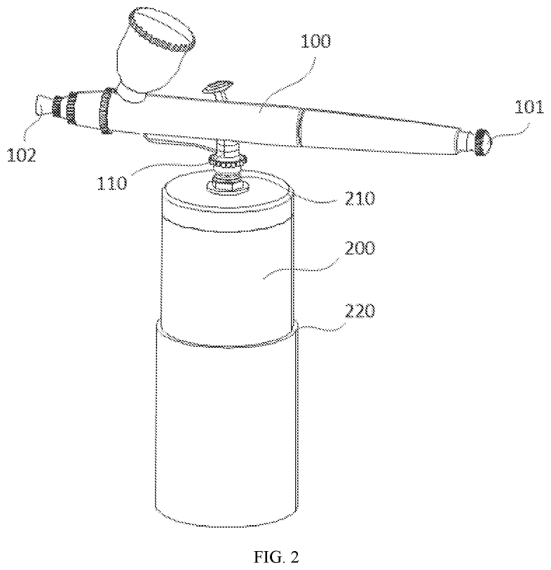

For example, the gripping sleeve 300 and the housing 200 are split structure, that is, the gripping sleeve 300 and the housing 200 are two independent portions, the air guiding connector 210 and the air inlet portion 110 are clamping connection or threaded connection. As shown in FIG. 1 and FIG. 2, one connection end of the air inlet portion 110 and the air guiding connector 210 is provided with internal threads, and the first end of the air guiding connector 210 is provided with external threads, the air guiding connector 210 and the air inlet portion 110 are threaded connection. During a connection process, holding the body 100 and the gripping sleeve 300, rotating the housing 200, the air guiding connector 210 and the air inlet portion 110; or holding the housing 200, rotating the body 100, the gripping sleeve 300, the air guiding connector 210 and the air inlet portion 110.

For example, when the gripping sleeve 300 and the housing 200 are fixed connection, that is, the housing 200 is sheathed in the gripping sleeve 300, and fixed with the housing 200, such as adhesive bonding. And the air guiding connector 210 and the air inlet portion 110 can adopt clamping connection or threaded connection. As shown in FIG. 11, one connection end of the air guiding connector 210 and the air inlet portion 110 is provided with internal threads, and the first end of the air guiding connector 210 is provided with external threads, the air guiding connector 210 and the air inlet portion 110 are threaded connection. As shown in FIG. 11, there's no protrusion 380 on the gripping sleeve, and the body 100 can rotate on the upper of the holder, thus realizing threaded connection between the air guiding connector 210 and the air inlet portion 110.

For example, the gripping sleeve 300 and the housing 200 are integrated molding, and the air guiding connector 210 and the air inlet portion 110 are clamping connection or threaded connection.

For example, when the gripping sleeve 300 and the housing 200 are split structure or fixed connection, the gripping sleeve is a soft adhesive holder, which can further increase the users comfort of holding the spray pen, reduce pen fatigue, and the grip sleeve 300 can avoid the problem of hands sweating and slipping when using the spray pen for a long time.

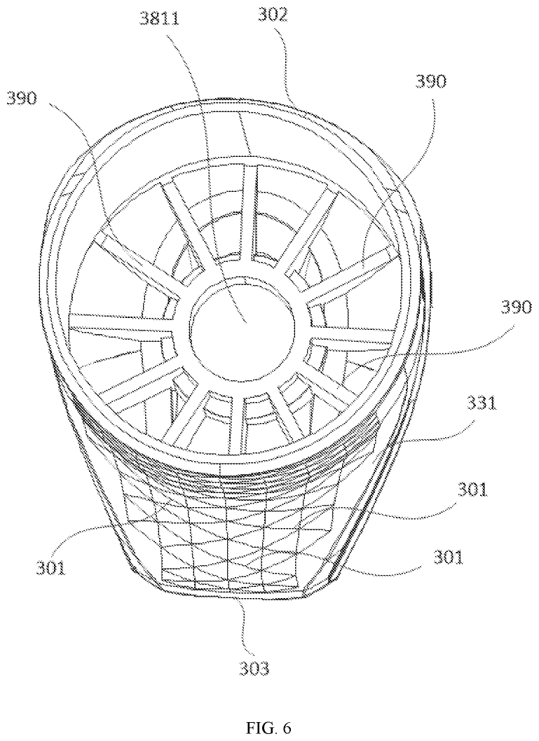

As shown in FIG. 6, in some embodiments, a plurality of reinforcements 390 are provided inside the gripping sleeve 300 near the mounting end, the plurality of the reinforcements 390 extend radially up to the gripping sleeve 300, and the plurality of the reinforcements 390 are distributed at circumferential intervals along the gripping sleeve 300. The reinforcements 390 enhanced the strength of the gripping sleeve 300, and decrease the deformation of the gripping sleeve 300 when it is held.

In some embodiments, among the plurality of the reinforcements 390, at least 3 reinforcements 390 toward a surface of the opening end 302 and fit a surface of the mounting end 303, to ensure that the soft rubber gripping sleeve is firmly placed on the housing 200 without any shaking, deflection, or other issues.

In some embodiments, as shown in FIG. 2, 1, a platform 220 is provided on an outer side of the housing 200, when the gripping sleeve 300 sheaths the housing 200, an end surface of the opening end 302 of the gripping sleeve 300 is located on the platform 220, thus making a circumferential outward side of the gripping sleeve 300 and a circumferential outward side of the platform 220 are aligned, and enhancing the aesthetics of the spray pen.

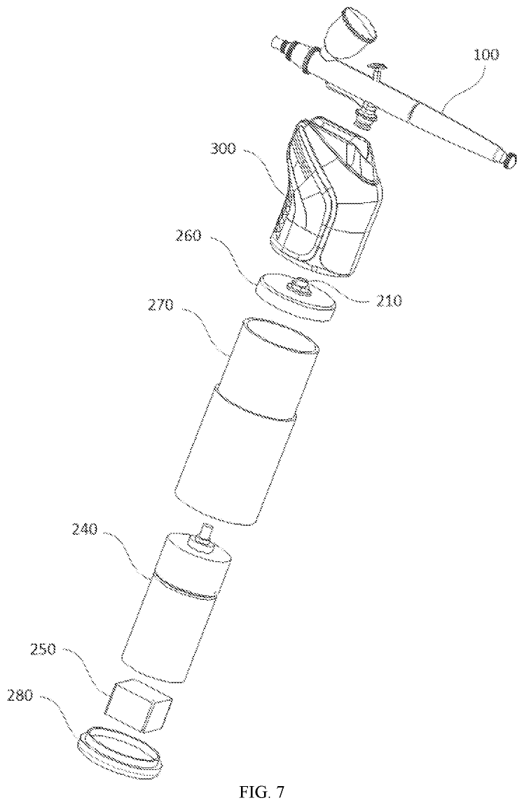

In some embodiments, as shown in FIG. 7, the spray pen also include the air pump 240 and a power supply 250, the air pump 240 and the power supply 250 are provided inside the housing 200, the air pump 240 is electrically connected with the power supply 250, and a air outlet of the air pump 240 is connected with a second end of the air guiding connector 210. The power supply 250 is configured to supply power to the air pump 240, and the air pumped by the air pump 240 is sent into the air inlet 210 through the air guiding connector 210. Providing the air pump 240 and the power supply 250 inside the housing 200, improving the flexibility of using a spray pen.

For example, when the air pump 240 and the power supply 250 are inside the housing 200, and installing a soft skin tube at the air outlet of the air pump 240, the air outlet with a soft skin tube is directly inserted into the transportation channel at the second end of the air guiding connector 210. The soft skin tube serves as a seal to prevent air leakage.

It is worth to noting that the spray pen can fit the structure with the air pump 240 and the power supply 250 provided inside the housing 200, but also fit the structure with a connecting pipe connected with the air pump. That is, when the air pump is big, and set as an external air pump of the spray pen, one end of the connecting pipe is sheathed on the second end of the air guiding connector 210, and another end of the connecting pipe is sheathed on the air outlet of the air pump, to realize the connection between the air guiding connector 210 and the air outlet of the air pump.

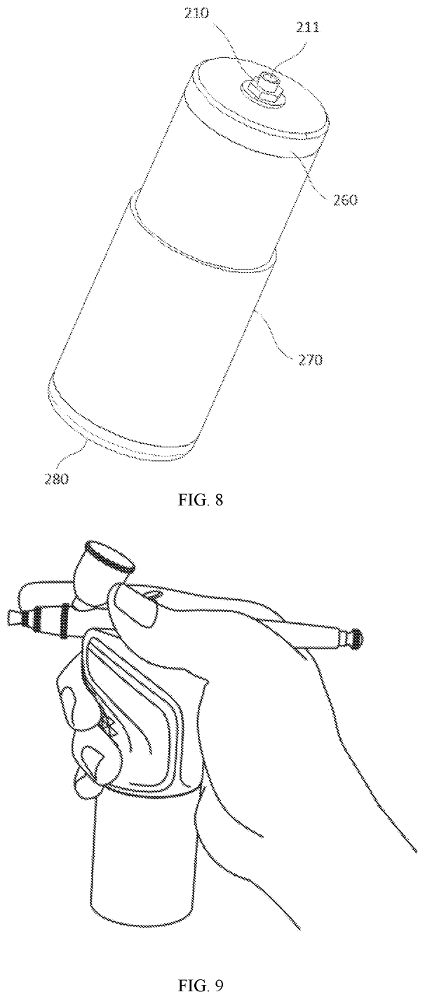

In some embodiment, as shown in FIG. 8, when the air pump 240 and the power supply 250 are inside the housing 200, the housing 200 includes a middle part 270, an upper part 260 and a lower part 280, the upper part 260 and the lower part 280 are detachable connected with two ends of the middle part 270, respectively; and the air guiding connector 210 is connected with the upper part of the housing 200. The upper part 260 facilitates the connection between the outlet of the air pump and the second end of the air guide connector 210, The lower part 280 facilitates the assembly of the power supply inside the housing 200.

### Embodiment 2

The second embodiment provides a spray pen, includes a body, a housing and a gripping sleeve, the structure of the body is the same as that provided in the first embodiment, further details are not describe any more.

In this embodiment, an air guiding connector is provided on the housing, the air guiding connector is connected with the air inlet; an air transportation channel is defined in the air guiding connector, and the air guiding connector is connected with an air pump; air pumped by the air pump being sent to the air inlet portion through the air transportation channel of the air guiding connector; the gripping sleeve is provided in the housing, the gripping sleeve is configured for an user to hold.

For example, the gripping sleeve includes a set part, and a gripping guiding part connected to the set part. The set part is set on the housing, and the gripping guiding part is configured for users to place some fingers to guide users to use the spray pen correctly, making it more comfortable for users to hold the spray pen and reducing pen fatigue.

The specific structure of the follow focus controller may refer to the foregoing embodiments. The follow focus system adopts all the technical solutions of the foregoing embodiments, so it at least has all the technical effects brought by the technical solutions of the foregoing embodiments, which is not detailed herein.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A spray pen, wherein, comprising:
a body, and the body comprises an air inlet portion;
a housing, and an air guiding connector is provided on the housing, the air guiding connector being connected with the air inlet; an air transportation channel being defined in the air guiding connector, and the air guiding connector being connected with an air pump; air pumped by the air pump being sent to the air inlet portion through the air transportation channel of the air guiding connector;
a gripping sleeve, the gripping sleeve being provided in the housing, the gripping sleeve is configured for an user to hold.

2. The spray pen according to claim 1, wherein, the gripping sleeve comprises a front surface, a rear surface and a first side top surface;
the front surface and the rear surface are located on opposite sides of the housing; and
the front surface and the rear surface are perpendicular to a first direction, wherein, the first direction is a direction from a tail of the body toward a nozzle of the body;
the first side top surface is located on a side of a front surface, and the first side top surface is configured for the user to place an index finger during using.

3. The spray pen according to claim 2, wherein, the gripping sleeve also comprises a second side top surface;
the first side top surface and the second side top surface are located on opposite sides of the body;
the second side top surface is configured for the user to place a thumb during using.

4. The spray pen according to claim 3, wherein, the first side top surface and the second side top surface are both tilted downward, and a tilt direction is opposite with the first direction.

5. The spray pen according to claim 4, wherein, an upper portion of the gripping sleeve is protruded forward along a nozzle end of the first direction.
the front surface comprises a first surface, a second surface, a third surface and a fourth surface;
the first surface is a protruded end surface of the gripping sleeve, and the first surface is configured for the user to place a middle finger during using;
the second surface is a protruded lower surface of the gripping sleeve, and the second surface is configured for the user to place a ring finger and a little thumb during using;
the third surface and the fourth surface are located on opposite sides of the first surface, and the third surface and the fourth surface both extend downward and extend to both sides of the second face.

6. The spray pen according to claim 5, wherein, the first side top surface and the second side top surface are smoothly transition connected with the rear surface;
the second surface is smoothly transition connected with the first surface;
the third surface and the fourth surface are smoothly transition connected with the second surface, respectively.

7. The spray pen according to claim 5, wherein, a first raised edge is provided between a first area and the third surface, and the first area is formed by the second side top surface and the rear surface;
a second raised edge is provided between a second area and the fourth surface, and the second area is formed by the first side top surface and the rear surface.

8. The spray pen according to claim 2, wherein, at least some area of the front surface is provided with anti-skid lines.

9. The spray pen according to claim 3, wherein, the gripping sleeve comprises an opening end and a mounting end, and the housing is sheathed in the gripping sleeve;
a protrusion is provided on the mounting end, and a installing slot is defined on the protrusion, a penetration hole is defined on a bottom of the installing slot, and the installing slot runs through both sides of the protrusion in the first direction;
the body is located in the installing slot, and two ends of the body extend from two ends of the installing slot along the first direction;
the air inlet portion and the air guiding connector are extended into the penetration hole, and connected inside the penetration hole;
the first side top surface and the second side top surface are located on two sides of the installing slot.

10. The spray pen according to claim 2, wherein, the gripping sleeve is fixed connected the housing.

11. The spray pen according to claim 9, wherein, the gripping sleeve and the housing are integrated molding.

12. The spray pen according to claim 8, wherein, the gripping sleeve is a soft adhesive holder.

13. The spray pen according to claim 12, wherein, a plurality of reinforcements are provided inside the gripping sleeve near the mounting end;
the plurality of the reinforcements extend radially up to the gripping sleeve, and the plurality of the reinforcements are distributed at circumferential intervals along the gripping sleeve.

14. The spray pen according to claim 13, wherein, among the plurality of the reinforcements, at least 3 reinforcements toward a surface of the opening end and fit a surface of the mounting end.

15. The spray pen according to claim 1, wherein, the spray pen also comprise the air pump and a power supply, the air pump and the power supply are provided inside the housing, the air pump is electrically connected with the power supply, and a air outlet of the air pump is connected with a second end of the air guiding connector.

16. The spray pen according to claim 1, wherein, a platform is provided on an outer side of the housing;
when the gripping sleeve sheaths the housing, an end surface of the opening end of the gripping sleeve is located on the platform.
